(19) United States
(12) Patent Application Publication
(10) Pub. No.: US 2007/0171902 A1
(43) Pub. Date: Jul. 26, 2007

(54) Method device for transmitting data packets belong to different users in a common transmittal protocol packet

(75) Inventors: Arne Simonsson, Gammelstad (SE); Jonas Pettersson, Lulea (SE); Anders Furuskar, Stockholm (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET LM ERICSSON, Stockholm (SE)

(21) Appl. No.: 10/585,093

(22) PCT Filed: Dec. 30, 2003
(86) PCT No.: PCT/SE03/02095

§ 371 Date: Jun. 30, 2006

(51) Int. Cl. H04L 12/56; H04L 12/28

(52) U.S. Cl. 370/389; 370/400

(57) ABSTRACT

The present invention relates to a method, device and system for handling short data packets, such as speech packets, in a communications network, and in particular a wireless local area network. The present invention is based on collecting several data packets from several users active on the network in one data transmittal protocol packet, transmitting this protocol, and receiving the protocol wherein the each of the several data packets are addressed to specific destinations. This reduces the overhead/data ratio and thus increases the capacity of the network.

### TECHNICAL AREA

The present invention relates to a method and device for transmitting and receiving data packets in a data transferring system, and in particular local area networks.

### BACKGROUND OF THE INVENTION

Communication of information and data uses a number of different channels and media, such as wired or wireless data communication networks, LAN's (Local Area Networks), Internet, GSM, to mention a few, where these networks have been designed originally for a specific purpose. Future communication systems will be multi-access systems, i.e. the communication systems will consist of overlapping radio access networks using different access technologies, for example a communication system may comprise a WCDMA network, a GSM network and a Wireless Local Area Network (WLAN) covering the same area. Multi-access systems have emerged because it is hard to design one single access technology suitable for all kinds of services and all deployment scenarios in a communication system (e.g. personal area networks, indoor areas, hotspots, wide area networks etc.). It is also costly to replace previous generations of systems because the operator may loose existing customer base and because the systems are widely deployed.

One such communication network that could be used in a multi-access system is the named LAN and in particular WLAN. One of the mostly used standards for WLAN is the IEEE standard 802.11. For transferring data over the WLAN, IEEE 802.11 systems use a Medium Access Control (MAC) protocol called Carrier Sense Multiple Access (CSMA). This MAC protocol consists of a rather large header comprising a destination address, a source address and a field indicating the type of protocol being carried, followed by the payload data frame and ending with a frame check sequence. According to the protocol MAC packets are separated by several time intervals, such as a back-off time and a shorter interframe space SIFS, and a distributed inter frame space, DIFS. Further overhead is also added by the physical layer. An example of the overhead caused by a simple data transmission is shown in FIG. 1.

When transmitting speech over a LAN or a WLAN using the MAC protocol, short speech packages generated by speech coders of the speech services are inserted into the data frame of a MAC packet. The MAC/PHY headers are thus very large in comparison with the data, forming a large overhead. Further the separation of the MAC packets by the time interval delays the transmission of the speech packets in for example the downlink from an access point of a WLAN network. The intervals and the MAC/PHY packets headers form a large overhead counted per packet when transmitting speech and this overhead is independent of the speech packet length.

A simple analysis of frame exchange and back-off times reveals some fundamental characteristics and limitations of the IEEE 802.11 MAC for supporting voice services.

The PLCP preamble and PLCP header together take 9×8/1 Mbps+6×8/2 Mbps=96 μs to transmit. Using 11 Mbps, the MAC header and FCS take (30+4)×8/11 Mbps=31 μs. Assuming a 64 kbps voice coder and a frame length of 20 ms, disregarding RTP/UDP/IP headers, the size of a voice frame is 64 kbps×20 ms=1280 bits. At 11 Mbps this takes 116 μs to transmit. Together this results in a total transmission time of 96 μs+31 μs+116 μs=243 μs. Before the next frame can be transmitted, an acknowledgement also has to be transmitted. The acknowledgement is sent 10 μs after the data frame is received. It has the same format as a data frame with an MSDU payload of 14 bytes. The transmission time for the acknowledgement, at 11 Mbps, is 96 μs+31 μs+14×8/11=137 μs. After the acknowledgement is sent the medium has to be left idle for at least 50 μs. The total frame exchange time is thus 243 μs+10 μs+137 μs+50 μs=440 μs. This corresponds to a relative overhead of (440 μs−116 μs)/440 μs=74%.

Another problem in the context of transmitting conversational speech is that the packets must be transmitted with low delay since long delays ruins the interaction of the conversation. It is thus generally not possible to wait, store or buffer speech packets to any larger extent, which may be done with other types of data.

The delay problem is also present when the network system uses Distributed Coordination Function, DCF, for avoiding collision of transmitted packets. The DCF involves listening to other stations that are transmitting and attempting collision avoidance through the use of random back-off timeouts. Collision avoidance is accomplished by requiring each device that is about to transmit to choose a random value within a specified range. Each device must then wait this random time period following the previous transmission before the start of its transmission. This results in an equal access probability for every transmitter.

With a WLAN using an access point and a number of mobile devices this implies that there is only one transmitter in the downlink (the access point) and several in the uplink (the mobile devices) whereby the access point, which can choose only one random number, has to compete with the devices, which in turn could mean a very unfavourable delay for the transmissions from the access point, since all these transmissions have to share an access probability that is equal to the uplink access probability.

Document U.S. Pat. No. 6,496,499 B1 discloses a method for coordinating isochronous devices accessing a wireless network in order to minimize the collision risk. However it does not address the inherent problems of the overhead of the MAC protocol, and the capacity problems this leads to as regards transmission of speech.

### BRIEF DESCRIPTION OF THE INVENTION

The aim of the present invention is to remedy the drawbacks of transmitting speech or other short packages over a communication network with relatively large overhead per package.

This aim is solved by the characterising features of claims 1, 18, 19, 20, 28 and 29.

Advantageous features of the invention are found in the dependent claims.

According to the present invention the main aim is to reduce the large overhead encountered when sending short packets such as speech in a local area network, using transmittal protocols such as the MAC protocol, which introduces a large overhead per packet.

This aim is solved by collecting several data packets in one data transmittal protocol packet, transmitting this protocol, and receiving the protocol wherein each of the several data packets are addressed to specific destinations.

The collection and transmittal of several data packets in one transmittal protocol packet, such as a MAC packet, will provide a reduction of the amount of overhead information per transmitted data packet, such as speech, thereby increasing the efficiency by which a radio channel is used. Also the delay caused by the back-off and SIFS intervals will be reduced, counted on a per packet basis. Also, in the event that a MAC packet has been scheduled to wait long before it is transmitted, which could be the case with DCF in the downlink, it can compensate for this long waiting time by being able to send large amounts of data in its payload.

With the present invention it is possible to use the LAN and WLAN in a multi-access system implementing speech as a data medium transmitted wherein the drawbacks of the WLAN in connection to speech has been greatly reduced. A more flexible use of existing network media for other and/or complimenting applications of use is obtained.

These and other features and advantages of the present invention will become apparent from the following detailed description of the invention.

### BRIEF DESCRIPTION OF THE DRAWINGS

In the following detailed description of the invention reference will be made to the accompanying drawings, of which

FIG. 1 is a schematic view of a MAC packet according to the prior art,

FIG. 2 is a schematic view of a wireless local area network WLAN,

FIG. 3 is a schematic view of a MAC packet according to the present invention, and

FIG. 4 shows an example of addressing speech packets according to the present invention.

### DETAILED DESCRIPTION OF THE INVENTION

The present invention relates to transmitting short packages over a LAN network, and in particular a wireless LAN, which packages may be speech packages that generally are rather short and further cannot be delayed for too long before they are transmitted.

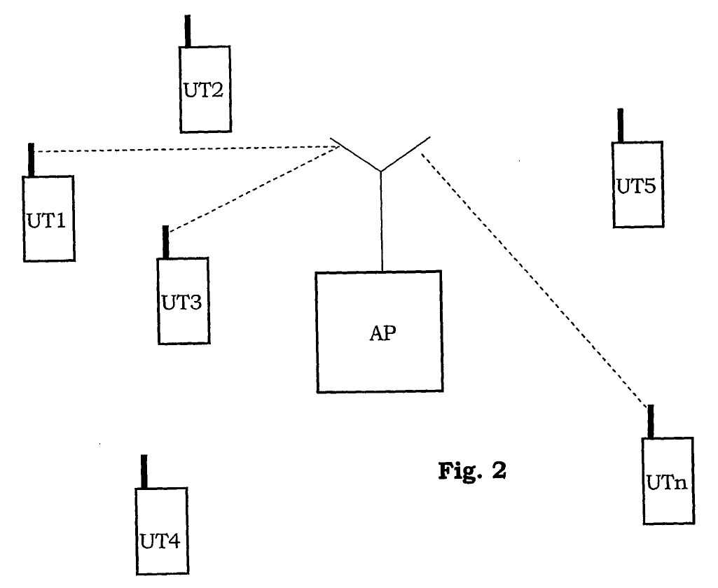

The general idea is to use the WLAN as a communication medium for speech as well as for conventional data transfer. This provides the possibility of having mobile telephone handsets within a building or a local area utilising an existing wireless network, originally intended for wireless connection of computers, printers, modems and the like electronic equipment. FIG. 2 shows a schematic example of a wireless communication network having an access point AP and a number of user terminals UT 1-n.

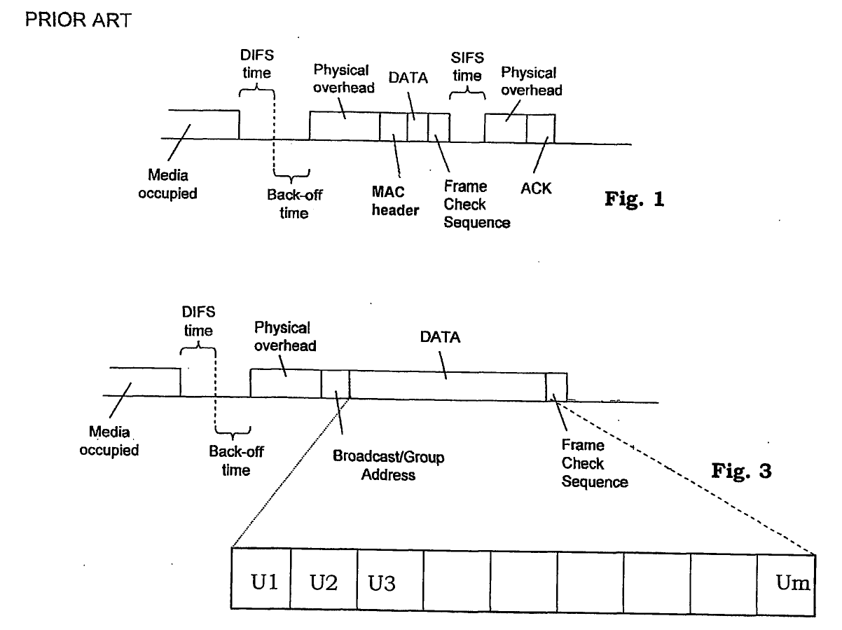

In such a network a data transmission protocol, in the detailed description a MAC protocol, is used to transmit data packets between the user terminals and the access point. It comprises a header comprising a destination address, a source address and a field indicating the type of protocol being carried and ending with a frame check sequence. According to the MAC protocol MAC packets are separated by several time intervals, such as a back-off time and a shorter inter frame space SIFS, and a distributed inter frame space, DIFS, FIG. 1.

The idea of the present invention is to collect, for one or more active users UT1-UTn, more than one speech packet and insert these into the data field of a MAC packet, at the access point AP, before transmitting it to one or more destination. The data field is thus divided into a number of speech frames, U1-Um, FIG. 3, where speech packets from several active user terminals are collected and inserted into the data field, thus “expanding” the data field compared to if only one speech packet would be inserted.

Since each speech packet is very short in comparison with the maximum length of the data field of the MAC packet a large number of speech packets from active user terminals may be inserted and transmitted to the respective destinations.

As an example, typically 50 speech packets per second are transmitted to a single user. If there are 10 active users then 500 MAC packets per second need to be transmitted with the conventional method of transmitting one speech packet per MAC packet. With the present invention, by collecting and transmitting several speech packets per MAC packet, the packets from these 10 active users are collected and inserted together in one MAC packet and, in case one speech packet per user is inserted in the MAC packet, subsequently only 50 MAC packets need to be transmitted. It is thus seen that the overhead/data ratio is reduced by a factor 10. Further reductions are possible if more than one speech packet per user is inserted in the MAC packet. This will however increase the speech packet delay.

In order for each speech packet in the collected MAC packet to reach its intended destination, it has to be provided with destination addresses. There are several known methods for addressing data packets known to the person skilled in the art that might be applicable.

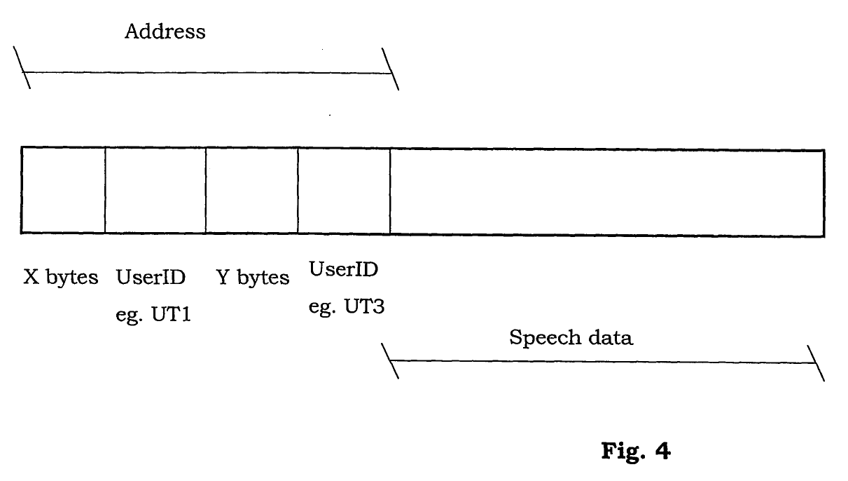

A few conceivable methods will be described. In one the existing MAC header is used, where this is set to a broadcast address, wherein the MAC packet is sent to all connected receivers, or is set to a multicast address, wherein the MAC packet is sent to group of predefined receivers, for sorting speech users from data users. For addressing each speech packet in the data field a destination address could be arranged first in the data field indicating that x number of bytes of the speech data belongs to a certain user ID, UT1 in the example of FIG. 4, followed by y number of bytes belonging to another user ID, UT3, etc, or for that matter the same user. In this context it is to be understood that the order also could be the reverse, ie. user ID first and then the number of bytes that belong to that user. If each speech frame was predefined and fixed regarding its byte size, it is possible to omit the number of bytes belonging to each user ID, and to merely have the user ID's in the address field where the speech packet of the first speech frame belongs to the first user ID in the address field, the speech packet of the second speech frame belongs to the second user ID and so on. The user ID could be a MAC address, an IP address or any other identifier that is unique within the network.

The collection of speech packets may be done in different ways such as within a defined time interval, which could be periodic or after first collected packet. The later is suitable when there are delay requirements for packets such as for speech. Other examples of collection principles are that a predetermined number of packets are stored, storing packets until a predefined data field size is filled up and/or packets from a predefined number of active users are stored before the MAC packet is transmitted. These properties may be fixed all the time or dynamically altered depending on the application and/or load on the network. One example of a data field size is the maximum segment size for the MAC protocol, 2346 bytes. Combinations of collection principles can also be applied, either to send MAC packet when several criteria are fulfilled or when one of several criteria is fulfilled. For example to send a MAC packet when either a defined data size is reached, to minimize overhead, or when a time since first collected data packet has elapsed, to still fulfill a delay requirement.

It is further conceivable to more directly connect the user ID and possibly the number of bytes belonging thereto to each speech packet in the data field instead of having the addresses in the beginning of the data field.

Another possibility is to modify the MAC header so that the destination address for each speech packet is arranged in the address field of the MAC header, thereby allowing for direct addressing of multiple users.

Several ways exist to do this. For example, the addressing principles described above and used in the data field could instead be used as a part of the MAC header.

As seen there are several possibilities of addressing each speech packet so that it reaches the intended destination.

As well as each MAC packet contains speech packets from different users it may of course contain more than one packet per user. If for example there are few active users several packets from one user could be inserted in one MAC packet. In some applications speech packets may be “mixed” with ordinary data packets if it is convenient for “filling” the data field of the MAC packet. Provisions must then be made to address the different parts of the data field.

It is further conceivable to implement the present invention such that speech packets from active users are stored in individual buffers that are connected to individual inputs of a time multiplex unit that at its output generates lumped or multiplexed speech packets.

The present invention of collecting speech packets from several active users also has the advantage, apart from reducing the overhead/data ratio, i.e. increasing the capacity, that it improves the transmission of packets in a WLAN with distributed coordination function, DCF, wherein the access point, having one random number trying to access the downlink, has to compete with several active mobile terminals on the network, all having the same probability. When the access point gets access to transmit, it actually sends data, speech packets, to several users in one transmission instead of only one user as with the conventional way. Thereby the reduced access probability per user in the downlink is counteracted.

Normally in transmitting data over a LAN using MAC protocol, an acknowledgement, ACK, is sent back to the transmitter that the packet has been received. With the present invention and a normal MAC packet configuration it is difficult to send an ACK, since different parts of the data field is received by different destinations. Further according to the IEEE 802.11 standard, regarding wireless LANs, no ACKs are sent in response to broadcast or multicast messages. Either the method according to the invention could accept that no ACKs are sent, this is often the case for speech transmitting systems, like GSM, or the MAC protocol could be modified allowing introduction of ACKs for example by letting users contend for the uplink using normal or modified channel access procedures when transmitting ACKs.

The transmittal packet containing several user packets could further be given priority by using any therefore available means in the communication network. In for example 802.11 wireless LAN, a shorter interframe space than DIFS could be used, or on average shorter back-off timers.

Even if the detailed description has shown its use for speech packets it is of course applicable to other types of small data packets, especially delay sensitive packets from different sources, for example network gaming. It is further applicable to any broadcast-capable communications network with a high overhead per packet.

It is to be understood that the embodiments described above and shown in the drawings only are to be regarded as non-limiting examples of the invention and that it may be modified within the scope of protection defined by the patent claims.

1. Method for transmitting data packets over a communications network, utilizing transmittal protocol packets comprising a header, which in turn comprises an address field, and a data field, characterised in collecting and inserting several data packets from several users active on the communications network into the data field of a transmittal protocol packet, and transmitting the transmittal protocol packet, wherein each inserted data pocket is associated an individual address.

2. Method according to claim 1, characterised in using a broadcast or group address in the header of the transmittal protocol and attaching an individual address to each data packet in the data field.

3. Method according to claim 1, characterised in arranging the individual addresses in the header of the transmittal protocol.

4. Method according to claim 1, characterised in that the transmittal protocol is a MAC protocol.

5. Method according to claim 4, characterised in that the MAC protocol is a Carrier Sense Multiple Access protocol.

6. Method according to claim 1, characterised in that the data packets comprises speech packets.

7. Method according to claim 1, characterised in the further step of storing a number of data packets before insertion into the data field.

8. Method according to claim 7, characterised in storing data packets collected within a defined time interval.

9. Method according to claim 7, characterised in storing a defined number of data packets.

10. Method according to claim 7, characterised in storing data packets filling up a defined data field size.

11. Method according to claim 7, characterised in the further step of storing data packets from several active users in individual buffers connected to individual inputs of a time multiplex unit.

12. Method according to claim 11, characterised in storing data packets from a defined number of active users.

13. Method according to claim 8, characterised in the further step of forwarding multiplexed data packets to a packetizing unit for insertion into the data field.

14. Method according to claim 1, characterised in that the local area network is wireless.

15. Method according to claim 10, characterised in that the collection is performed in an access point.

16. Method according to claim 1, characterised in that the transmittal protocol containing data packets from several users is given transmission priority.

17. Method of receiving data packets transmitted according to claim 1, characterised in receiving the transmittal protocol packet, identifying the address of the header of the transmittal protocol packet, and if correct, collecting at least one of the data packets in the data field of the transmittal protocol packet.

18. Computer program product comprising computer code means and/or software code portions for making a computer or processor perform the steps of claim 1.

19. Device for transmitting data packets over a communications network, utilizing transmittal protocol packets comprising a header, which in turn comprises an address field, and a data field, characterised in means for collecting and inserting several data packets from several users active on the communications network into the data field of a transmittal protocol packet, means for transmitting the transmittal protocol packet and means for associating an inserted data packet with an individual address.

20. Device according to claim 19, characterised in using a broadcast or group address in the header of the transmittal protocol and means for attaching an individual address to each data packet in the data field.

21. Device according to claim 19, characterised in means for arranging the individual addresses in the header of the transmittal protocol.

22. Device according to claim 1, characterised in that the transmittal protocol is a MAC protocol and that the data packets comprises speech packets.

23. Device according to claim 22, characterised in that the MAC protocol is a Carrier Sense Multiple Access protocol.

24. Device according to claim 1, characterised in the means for storing a number of data packets before insertion into the data field.

25. Device according to claim 24, characterised in means for storing data packets from several active users in individual buffers connected to individual inputs of a time multiplex unit.

26. Device for receiving data packets transmitted from the device according to claim 19, characterised in means for receiving the transmittal protocol packet, means for identifying the address of the header of the transmittal protocol packet, and if correct, means for collecting at least one of the data packets in the data field of the transmittal protocol packet.

27. System for handling data packets on a communications network, utilizing transmittal protocol packets comprising a header, which in turn comprises an address field, and a data field, comprising means for collecting and inserting several data packets from several users active on the communications network into the data field of a transmittal protocol packet, means for transmitting the transmittal protocol packet, means for associating an inserted data packet with an individual address, means for receiving the transmittal protocol packet, means for identifying the address of the header of the transmittal protocol packet, and if correct, means for collecting at least one of the data packets in the data field of the transmittal protocol packet.

28. System according to claim 27, characterised in that the local area network is wireless.

29. System according to claim 28, characterised in that the collection is performed in an access point.
